(19) United States
(12) Patent Application Publication
(10) Pub. No.: US 2004/0174385 A1
(43) Pub. Date: Sep. 9, 2004

(54) Image composition device and image composition method

(76) Inventors: Masaki Ikeda, Tonami-shi (JP); Hiroyuki Ito, Kawasaki-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/472,825

(22) PCT Filed: Jan. 31, 2003
(86) PCT No.: PCT/JP03/00960

(30) Foreign Application Priority Data
Feb. 7, 2002 (JP) 2002-31261

(51) Int. Cl. G09G 5/00

(52) U.S. Cl. 345/629

(57) ABSTRACT

An image combining apparatus and an image combining method for minimizing the occupation of busses and for combining images at high performance and low power consumption. An image data memory (100) generates update history information that indicates which image data is updated. A combiner (110) reads only updated image data based on the update history information and generates combined image updating data. A display control information generator (120) generates display control information containing transparent data and non-transparent data, respectively indicating the transparent portion and the non-transparent portion of the combined image updating data. A writer (150) writes the combined image updating data into a combined image memory (160). Then, the writer (150) writes the combined image updating data over a previously generated combined image, letting the portion corresponding to the transparent data in the display control information be transparent, and not letting the portion corresponding to the non-transparent data pass.

### TECHNICAL FIELD

The present invention relates to an image combining apparatus and an image combining method.

### BACKGROUND ART

Recent years have seen a voluminous growth of image data in communication terminal apparatus as typified by mobile telephones, such as the change of display images from black-and-white images to color images. Additionally, it has become obligatory to combine image data such as still images, moving images, and graphics, upon display. For instance, an image combining apparatus that combines a plurality of image data upon display is disclosed in unexamined Japanese patent application publication No. HEI6-274155.

However, with conventional image combining apparatus, when for instance graphic image data and moving image data are combined, if only one of them is updated, both the graphic image data and the moving image data are read from a memory and combined. Reading unupdated and thus unnecessary image data occupies more busses as a result, which then leads to the problems of poor performance of the apparatus and increased power consumption.

### DISCLOSURE OF INVENTION

It is therefore an object of the present invention to minimize the occupation of busses and combine images at high performance and low power consumption.

The essence of the preset invention lies in reading only updated image data from a memory and generating updating combined images, and writing the generated updating combined images over previously combined images.

In accordance with one embodiment of the present invention, there is provided an image combining apparatus that generates a combined image made up of a plurality of image data, comprising: a memory that memorizes the plurality of image data; a combiner that generates an updating combined image using updated image data among the memorized plurality of image data; a generator that generates display control information indicating a display portion and a non-display portion of the generated updating combined image; and a writer that, in accordance with the generated display control information, writes the generated updating combined image over a previously generated combined image.

In accordance with another embodiment of the present invention, there is provided an image combining method for generating a combined image made up of a plurality of image data, comprising the steps of: generating an updating combined image using updated image data among a plurality of memorized image data; generating display control information indicating a display portion and a non-display portion of the generated updating combined image; and writing the generated updating combined image over a previously generated combined image in accordance with the generated display control information.

### BRIEF DESCRIPTION OF DRAWINGS

FIG. 1 is a block diagram showing a configuration of an image combining apparatus according to the first embodiment of the present invention;

FIG. 2 is a diagram for specifically describing an example of the operation of the image combining apparatus of the first embodiment;

FIG. 3 is a block diagram showing a configuration of an image combining apparatus according to the second embodiment of the present invention;

FIG. 4 is a diagram for specifically describing an example of the operation of the image combining apparatus of the second embodiment;

FIG. 5 is a diagram for specifically describing an example of the operation of an image combining apparatus according to the third embodiment of the present invention;

FIG. 6 is a diagram for specifically describing an example of the operation of an image combining apparatus according to the fourth embodiment of the present invention;

FIG. 7 is a diagram showing an example of coordinates of image combined data according to the fourth embodiment;

FIG. 8 is a block diagram showing a configuration of an image combining apparatus according to the fifth embodiment of the present invention; and

FIG. 9 is a diagram for specifically describing an example of the operation of the image combining apparatus of the fifth embodiment.

### BEST MODE FOR CARRYING OUT THE INVENTION

With reference to the accompanying drawings now, embodiments of the present invention will be described in detail.

(Embodiment 1)

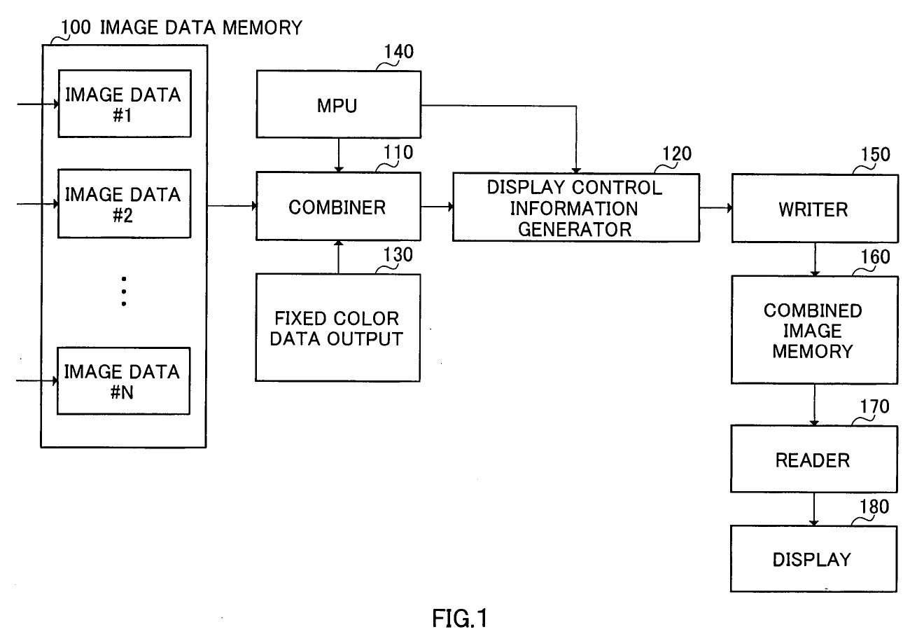

FIG. 1 is a block diagram showing a configuration of an image combining apparatus according to the first embodiment of the present invention.

In FIG. 1, image data memory 100 memorizes a number of image data. Additionally, when any one of multiple image data #1-#N that are memorized is updated by an unshown apparatus that outputs image data such as a camera, image data memory 100 outputs update history information indicating which image data is updated to combiner 110. When the update history information is output from image data memory 100, in accordance with this output update history information, combiner 110 reads only the updated image data among multiple data #1-#N. Then, combiner 110 generates an updating combined image using the read image data and fixed color data that is output from fixed data output 130.

Display control information generator 120 generates display control information that contains transparent data representing the transparent portion of the updating combined image generated by combiner 110 and non-transparent data representing the non-transparent portion of the updating combined image. Of the updating combined image here, a portion corresponding to the transparent data in the display control information becomes a non-display portion as it is transparent when an image is displayed, and a portion corresponding to the non-transparent data is non-transparent and becomes a display portion. Fixed color data output 130 outputs fixed color data that is going to be combined with image data in combiner 110. Incidentally, fixed color data refers to data that carries no specific information and that, being a portion corresponding to the transparent data of the display control information, becomes a non-display portion.

MPU (Micro Processing Unit) 140 controls combiner 110 and display control information generator 120, whereby an updating combined image and display control information are generated. Writer 150 writes the updating combined image generated in combiner 110 into combined image memory 160. Writer 150 then, following the display control information generated in display control information generator 120, lets the portion of the updating combined image that corresponds to the transparent data in the display control information be transparent, while not letting the portion that corresponds to the non-transparent data in the display control information be transparent, and generates a combined image by writing the generated updating combined image over a previously generated combined image.

Combined image memory 160 memorizes the combined image generated by the writing of the updating combined image by means of writer 150. Reader 170 reads the combined image memorized in combined image memory 160 and outputs it to display 180 which will be described later. Display 180 displays the combined image output from reader 170.

Next, the operation of an image combining apparatus configured as above will be described.

When even only one of a plurality of data #1-#N memorized in image data memory is updated by an unshown apparatus that outputs image data such as a camera, update history information that indicates which image data is updated is output to combiner 110. Then in accordance with the update history information, only the updated image data is read by combiner 110.

Then, combiner 110 is controlled by MPU 140 and the updated image data and fixed color data that is output from fixed color data output are placed in predetermined positions and combined, and an updating combined image is thus generated. Then, display control information generator 120 is controlled by MPU 140, and display control information is generated in which non-transparent data is placed in the portion corresponding to updated image data and in which transparent data is placed in the portion corresponding to fixed color data.

Then, the updating combined image and the display control information are output to writer 150. The portion of the updating combined image that corresponds to the non-transparent data in the display control information is written over a previous combined image memorized in combined image memory 160. On the other hand, the portion of the updating combined image that corresponds to the transparent data in the display control information is not written over the previous combined image memorized in combined image memory 160.

In this way, the combined image memorized in combined image memory 160 is updated, as only the portion thereof corresponding to those of image data #1-#N memorized in image data memory 100 that are updated is written over and modified.

Then, the combined image is read by reader 170 from combined image memory 160, and the read combined image is displayed by means of display 180.

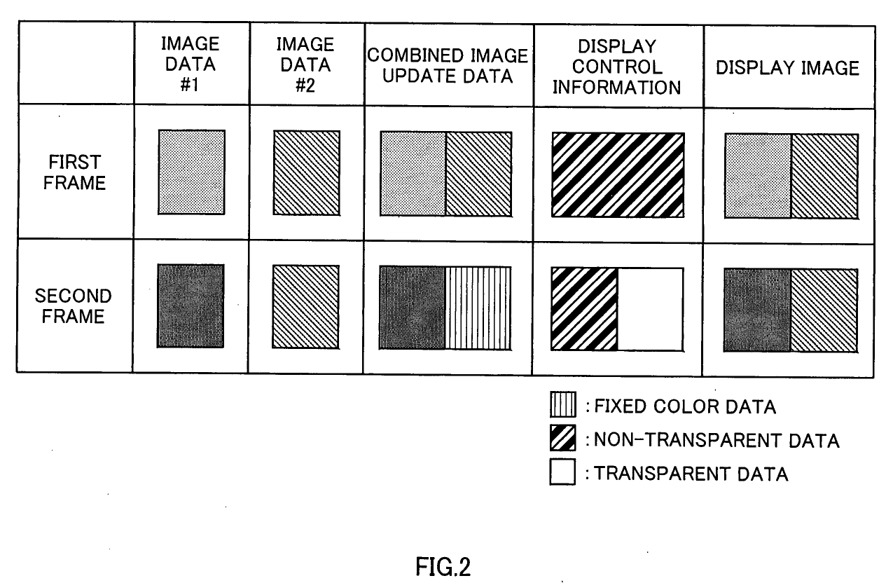

Next, a specific example of the operation of the image combining apparatus of the present embodiment will be described with reference to FIG. 2.

FIG. 2 shows an example of the operation of the image combining apparatus of the present embodiment. The figure shows the operation of the case where only image data #1 of image data #1 and image data #2 memorized in image data memory 100 is updated.

First, image data #1 and image data #2 of the first frame are read from image data memory 100 by combiner 110, and image data #1 and #2 that are read are placed in predetermined positions, and an updating combined image is thus generated. Now, given that the updating combined image that is generated is for the first frame, it is possible to assume that this is a case where all image data #1 and #2 memorized in image data memory 100 are updated, and no fixed color data is output from fixed color data output 130.

Then, with display control information generator 120 controlled by MPU 140, display control information is generated in which non-transparent data is placed in the portion corresponding to updated image data #1 and #2, that is, the portion corresponding to the whole of the updating combined image.

Then, the updating combined image and the display control information are output to writer 150, and, in accordance with the display control information, the whole of the updating combined image becomes non-transparent and is output to combined image memory 160 as a combined image. Then, the combined image is read from combined image memory 160 by reader 170 and displayed on display 180 as a display image. The combined image memorized in combined image memory 160 then is not deleted and kept memorized even after being read by reader 170.

Next, referring to the second frame, when only image data #1 memorized in image data memory 100 is updated, update history information indicating to that effect is output to combiner 110. Then, updated image data #1 is read from image data memory 100 by combiner 110, and image data #1 that is read is placed in a predetermined position. At the same time, fixed color data is output from fixed data output 130 and the output fixed color data is then output to the portion corresponding to unupdated image data #2, and an updating combined image is thus generated.

Display control information is thus generated, in which the non-transparent data is placed in the portion corresponding to updated image data #1 and in which the transparent data is placed in the portion corresponding to unupdated image data #2.

Then, the updating combined image and the display control information are output to writer 150, and in accordance with the display control information, the portion of the updating combined image that corresponds to updated image data #1 becomes non-transparent, and the combined image of the first frame memorized in combined image memory 160 is written over. Also, the portion of the updating combined image that corresponds to unupdated image data #2 (that is, the fixed color data portion) becomes transparent and the combined image of the first frame memorized in combined image memory 160 is not written over.

Looking at the then displayed image on display 180, the portion corresponding to updated image data #1 displays the updated image, and the portion corresponding to unupdated image data #2 displays the image of the first frame.

As described above, the image combining apparatus of the present embodiment is configured to, where there are a plurality of image data, read only that that is updated, place fixed color data in the portion corresponding to unupdated image data, combine the fixed color data with updated image data, and write only the updated portion over a previously combined image, so that it is not necessary to read unupdated image data, and it is thus possible to minimize the occupation of busses and combine images at high performance and low power consumption.

(Embodiment 2)

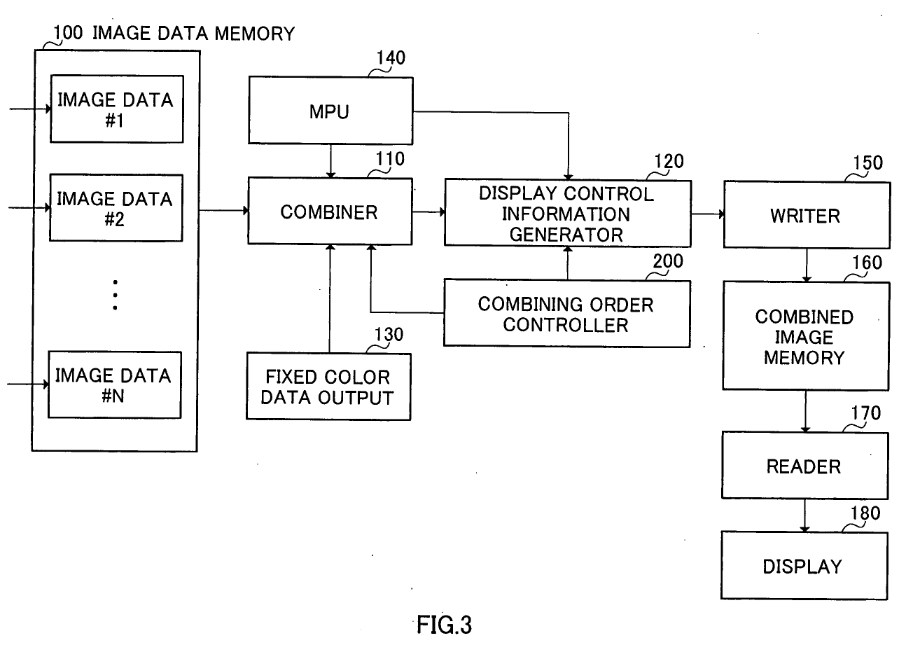

FIG. 3 is a block diagram showing a configuration of an image combining apparatus according to the second embodiment of the present invention. Parts in FIG. 3 identical to those of FIG. 1 are assigned the same numerals as in FIG. 1 without further explanations.

One of the features of the present embodiment is that, when a number of image data that are going to be combined have an overlapping portion, the combining order of the image data is controlled by way of generating display control information in accordance with the priority of the image data. Incidentally, the priority of image data refers to the order in which the multiple image data are superposed, and image data of high priority is superposed over image data of a low priority.

Referring to FIG. 3, combining order controller 200 outputs priority information that determines the priority of each image data with respect to the portion where image data read by combiner 110 overlap, to combiner 110 and to display control information generator 120.

Next, the operation of an image combining apparatus configured as above will be described.

According to this embodiment, as in the first embodiment, when any one of memorized image data #1-#N is updated by an unshown apparatus that outputs image data such as a camera, update history information that indicates which image data is updated is output to combiner 110. Then, in accordance with this update history information, only updated image data is read by combiner 110.

Then, combiner 110 is controlled by MPU 140, and the updated image data and fixed color data that is output from fixed color output 130 are placed in predetermined positions. At the same time, the overlapping parts are determined their priority based on the priority information output from combining order controller 200 and are combined, and an updating combined image is thus generated. Then, in accordance with control of MPU 140 over display control information generator 120 and the priority information output from combining order controller 200, non-transparent data is placed in the portion that corresponds to the updated image data and that carries no image data of higher priority than this image data. On the other hand, the display control information is generated in which transparent data is placed in the portion that corresponds to the updated image data and carries no image data of higher priority than this image data and in the portion that corresponds to the fixed color data.

Then, the updating combined image and the display control information are output to writer 150, and the portion of the updating combined image that corresponds to the non-transparent data of the control display information is written over the previous combined image memorized in combined image memory 160. The portion of the updating combined image that corresponds to the transparent data in the display control information is not written over the previous combined image memorized in combined image memory 160.

In this way, the combined image memorized in combined image memory 160 is updated, as only the portion thereof that corresponds to those of image data #1-#N memorized in image data memory 100 that are updated is written over and changes, and furthermore, in case image data of low priority is updated, there is no threat of writing over and changing the part that overlaps with image data of high priority.

Then, the combined image is read by reader 170 from combined image memory 160, and the read combined image is displayed by means of display 180.

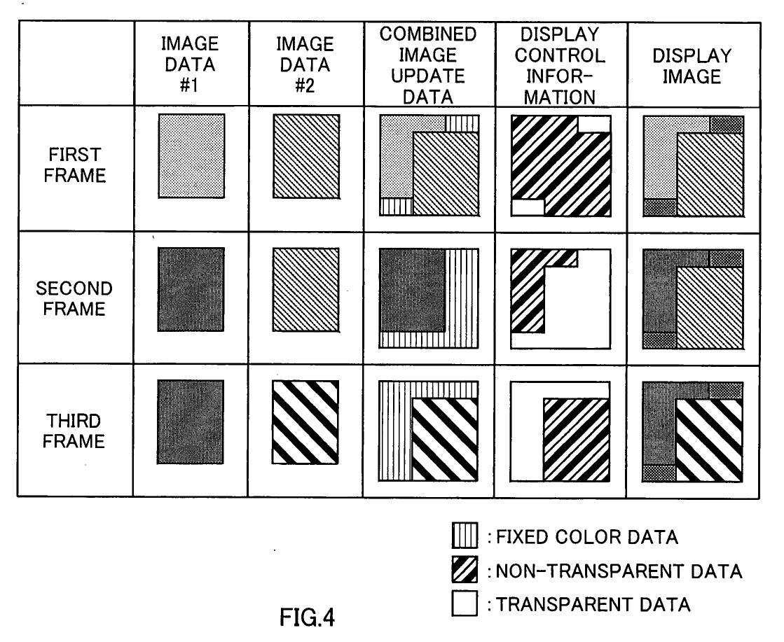

Next, a specific example of the operation of the image combining apparatus of the present embodiment will be described with reference to FIG. 4.

FIG. 4 shows a specific example of the operation of the image combining apparatus of the present embodiment. The figure shows a case where, of image data #1 and #2 memorized in image data memory 100, image data #1 alone is updated in the second frame and image data #2 alone is updated in the third frame. Assume that image data #2 has higher priority than image data #1.

First, the same processings are performed as in the first embodiment, and the combined image of the first frame that combines image data #1 and image data #2 is memorized in combined image memory 160, and the combined image is read by reader 170 and displayed as a display image by means of display 180.

Next, referring to the second frame, when only image data #1 memorized in image data memory 100 is updated, update history information indicating to that effect is output to combiner 110. Then, updated image data #1 is read from image data memory 100 by combiner 110, and image data #1 that is read is placed in a predetermined position. At the same time, fixed color data output 130 outputs fixed color data, and the fixed color data that is output is placed in the portion of the updating combined image data that does not correspond to image data #1, and the overlapping parts are determined their priority based on the priority information output from combining order controller 200 and are combined, and an updating combined image is thus generated. However, in FIG. 4, image data #1 alone is updated, and so there are no overlapping parts, and the updating combined image has no priority.

Then, in accordance with the priority information output from combining order controller 200, display control information is thus generated in which the non-transparent data is placed in the portion that corresponds to updated image data #1 and where image data #1 and image data #2 do not overlap. On the other hand, the transparent data is placed in the portion that corresponds to updated image data #1 and where image data #1 and image data #2 overlap, and in the portion that corresponds to fixed color data.

Then, the updating combined image and the display control information are output to writer 150, and in accordance with the display control information, the portion of the updating combined image that corresponds to updated image data #1 and where image data #1 and image data #2 do not overlap becomes non-transparent, and the combined image of the first frame memorized in combined image memory is written over. Moreover, the portion of the updating combined image that corresponds to updated image data #1 and where image data #1 and #2 overlap, and the portion that corresponds to fixed color data become transparent, and the combined image of the first frame memorized in combined image memory 160 is not written over. Then, the combined image is read from combined image memory 160 by reader 170 and displayed as a display image by means of 180.

Looking at the then displayed image on display 180, in the portion that corresponds to updated image data #1 and where image data #1 and image data #2 do not overlap, the updated image is displayed, and in the remaining portion, the image of the first frame is displayed.

Next, when image data #2 alone memorized in image data memory 100 is updated, update history information indicating to that effect is output to combiner 110. Then, updated image data #2 is read from image data memory 100 by combiner 110, and image data #2 that is read is placed in a predetermined position. At the same time, fixed color data is output from fixed color data output 130, and the output fixed color data is placed in the portion of the updating combined image that does not correspond to image data #2. Then, in accordance with the priority information output from combining order controller 200, the priority of the overlapping parts is determined to combine all data, and an updating combined image is thus generated. However, in FIG. 4, image data #2 alone is updated, and so there are no overlapping parts and the updating combined image has no priority.

Then, based on the priority information that is output from combining order controller 200, display control information is generated in which non-transparent data is placed in the portion that corresponds to updated image data #2, and transparent data is placed in the portion that corresponds to the fixed color data.

Then, the updating combined image and the display control information are output to writer 150, and in accordance with the display control information, the portion of the updating combined image that corresponds to updated image data #2 becomes non-transparent and the combined image of the second frame memorized in combined image memory 160 is written over. Moreover, the portion of the updated combined image that does not correspond to fixed color data becomes transparent and the combined image of the second frame memorized in combined image memory 160 is not written over. Then, the combined image is read from combined image memory 160 by reader 170 and displayed as a display image on display 180.

Looking at the then displayed image on display 180, in the portion that corresponds to updated image data 2, the updated image is displayed, and in the remaining portion, the image of the first frame is displayed.

As described above, the image combining apparatus of the present embodiment is configured to, where there are a plurality of image data memorized, read only that that is updated, place fixed color data in the portion that does not correspond to updated image data, combine the updated image data with fixed color data, and write only the portion that corresponds to the updated image data and that carries no image data of higher priority than the above image data over a previously combined image, so that even when a plurality of image data that are to be combined have an overlapping part, it is possible to minimize the occupation of busses and combine images with high performance and at low power consumption.

(Embodiment 3)

One of the features of the third embodiment is that, when a number of image data that are going to be combined have an overlapping portion, an updating combined image and display control information are generated in accordance with the priority of the image data to control the combining order of the image data.

Incidentally, the configuration of the image combining apparatus according to the present embodiment is the same as that of the image combining apparatus of the second embodiment (FIG. 3).

In the present embodiment, as in the first and second embodiments, when any one of memorized image data #1-#N is updated by an unshown apparatus that outputs image data such as a camera, update history information that indicates which image data is updated is output to combiner 110. Then, based on this update history information, the updated image data alone is read by combiner 110.

Then, based on control of MPU 140 over combiner 110 and priority information that is output from combining order controller 200, the portion of the updated image data that carries no image data of higher priority than the above image data, and fixed color data that is output from fixed color data output 130 are placed in predetermined positions and are combined, and an updating combined image is thus generated.

Thereafter, through the same processings as in the second embodiment, display control information is generated by display control information generator 120, and in accordance with the generated display control information, the updating combined image is written into combined image memory 160 and displayed on display 180.

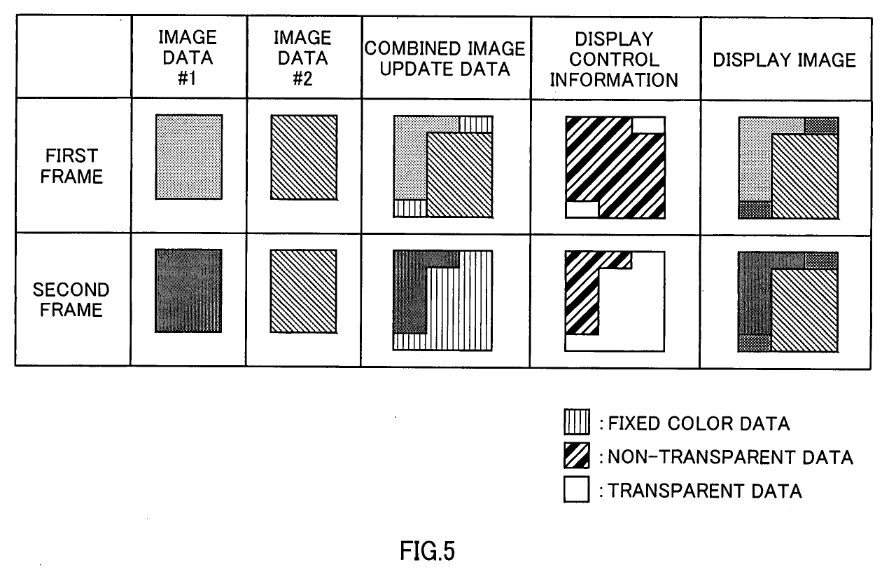

Next, a specific example of the operation of the image combining apparatus of the present embodiment will be described with reference to FIG. 5.

FIG. 5 shows an example of the operation of the image combining apparatus according to the present embodiment. The figure shows a case where, of image data #1 and #2 memorized in image data memory 100, image data #1 alone is updated in the second frame and image data #2 alone is updated in the third frame. Assume that image data #2 has higher priority than image data #1.

First, the same processings are performed as in the first and second embodiments, and the combined image of the first frame that combines image data #1 and image data #2 is memorized in combined image memory 160, and the combined image is read by reader 170 and displayed as a display image by means of display 180.

Next, when only image data #1 memorized in image data memory 100 is updated, update history information indicating to that effect is output to combiner 110. Then, updated image data #1 is read from image data memory 100 by combiner 110, and in accordance with priority information that is output from combining order controller 200, the portion of updated image data #1 that does not overlap with image data #2 is placed in a predetermined position. At the same time, fixed color data output 130 outputs fixed color data, and the fixed color data that is output is placed in the portion of the updating combined image portion besides the above and combined, and an updating combined image is thus generated.

Then, in accordance with the priority information output from combining order controller 200, display control information is thus generated, in which non-transparent data is placed in the portion that corresponds to updated image data #1 and where image data #1 and image data #2 do not overlap. On the other hand, transparent data is placed in the portion that corresponds to updated image data #1 and where image data #1 and image data #2 overlap, and in the portion that corresponds to fixed color data.

Then, the updating combined image and the display control information are output to writer 150, and in accordance with the display control information, the portion of the updating combined image that corresponds to updated image data #1 and where image data #1 and image data #2 do not overlap becomes non-transparent, and the combined image of the first frame memorized in combined image memory is written over. Moreover, the portion of the updating combined image that corresponds to updated image data #1 and where image data #1 and #2 overlap, and the portion that corresponds to fixed color data become transparent, and the combined image of the first frame memorized in combined image memory 160 is not written over. Then, the combined image is read from combined image memory 160 by reader 170 and displayed as a display image by means of 180.

Looking at the then displayed image on display 180, in the portion that corresponds to updated image data #1 and where image data #1 and image data #2 do not overlap, the updated image is displayed, and in the remaining portion, the image of the first frame is displayed.

As described above, the image combining apparatus of the present embodiment is configured to, in updated image data of an updating combined image, place fixed color data in the portion that overlaps with image data of higher priority than the above image data, so that there is no fluctuation of electrical signals, and consequently it is possible to reduced the power consumed in PAD (Padding) which is for adding fixed colors to updated image data.

(Embodiment 4)

One of the features of the fourth embodiment of the present invention is the generation of updating combined images and display control information corresponding to updated image data and corresponding to minimum necessary portion.

Incidentally, the configuration of the image combining apparatus according to the present embodiment is the same as that of the image combining apparatus of the second embodiment (FIG. 3).

In the present embodiment, as in the first through third embodiments, when any one of memorized image data #1-#N is updated by an unshown apparatus that outputs image data such as a camera, update history information that indicates which image data is updated is output to combiner 110. Then, based on this update history information, the updated image data alone is read by combiner 110.

Then, as in the third embodiment, based on control of MPU 140 over combiner 110 and priority information that is output from combining order controller 200, the portion of the updated image data that carries no image data of higher priority than the above image data, and fixed color data that is output from fixed color data output 130 are placed in predetermined positions and are combined, and an updating combined image is thus generated. The updating combined image generated here includes the updated image data and has a minimum necessary size.

Then, in accordance with control of MPU 140 over display control information generator 120 and the priority information that is output from combining order controller 200, display control information is thus generated, in which non-transparent data is placed in the portion that corresponds to the updated image data and where there is no image data of higher priority than the above image data. On the other hand, display control information is generated in which transparent data is placed in the portion that corresponds to updated image data and where there is image data of higher priority than the above image data, and in the portion that corresponds to fixed color data. Similar to the above described updating combined image, the display control information generated here includes the portion of the updated image data and has a minimum necessary size.

Then, the updating combined image, the display control information, and the coordinate information of the updating combined image and the display control information are output to writer 150. In accordance with the display control information and the coordinate information of these, the portion of the updating combined image that corresponds to non-transparent data of the display control information written over a previous combined image memorized in combined image memory 16-0, and the portion of the updating combined image that corresponds to transparent data of the display control information is not written over the previous combined image memorized in combined image memory 160.

Then, the combined image is read from combined image memory 160 by reader 170 and displayed as a display image by means of display 180.

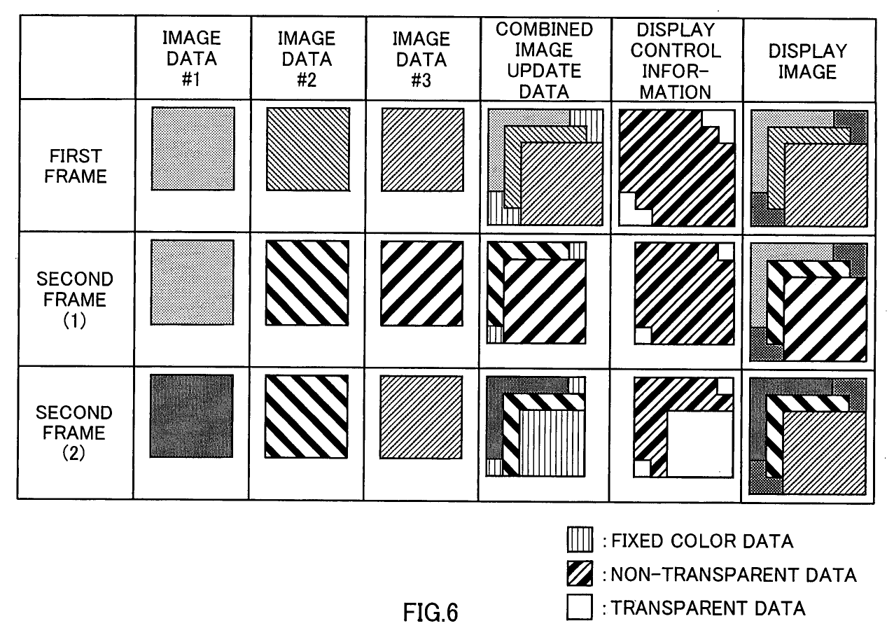

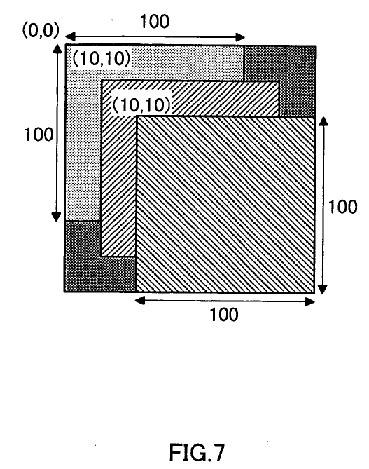

Next, a specific example of the operation of the image combining apparatus of the present embodiment will be described with reference to FIG. 6 and FIG. 7.

FIG. 6 shows a specific example of the operation of the image combining apparatus of the present embodiment. The figure shows a case where, of image data #1-#3 memorized in image data memory 100, image data #2 and #3 are updated in the second frame (the second frame (1)), and image data #1 and #2 are updated in the second frame (the second frame (2)). As of the priority, image data #3 is the highest and image data #1 is the lowest.

Moreover, as shown in FIG. 7, image data #1 has its origin at coordinate (0, 0) and has the size of 100×100, and image data #2 has its origin at coordinate (10, 10) and has the size of 100×100, and image data #3 has its origin at coordinate (20, 20) and has the size of 100×100.

First, the same processings are performed as in the first through third embodiments, and the combined image of the first frame that combines image data #1-#3 is memorized in combined image memory 160, and the combined image is read by reader 170 and displayed as a display image by means of display 180.

Next, when image data #2 and #3 memorized in image data memory 100 are updated, update history information indicating to that effect is output to combiner 110. Then, updated image data #2 and #3 are read from image data memory 100 by combiner 110, and in accordance with priority information that is output from combining order controller 200, the portion of update image data #2 that does not overlap with image data #3 and updated image data #3 are placed in predetermined positions. At the same time, fixed data output 130 outputs fixed color data, and the fixed color data that is output is placed in the portion of the updating combined image portion besides the above and combined, and an updating combined image is thus generated. The updating combined image generated here does not include the unupdated portion and has a minimum necessary size.

Then, in accordance with control of MPU 140 over display control information generator 120 and the priority information that is output from combining order controller 200, display control information is generated in which non-transparent data is placed in the portion that corresponds to updated image data #2 and #3, and transparent data is placed in the portion that corresponds to fixed color data. Similar to the above described display combined image, the display control information generated here does not contain the portion that corresponds to unupdated image data and has a minimum necessary size.

Then, the updating combined image, the display control information, and the writing-start position (10, 10) and the writing size of 110×110, which are coordinate information of the updating combined image, are output to writer 150. In accordance with the display control information and the coordinate information of these, the portion of the updating combined image that corresponds to the non-transparent data in the display control information is written over the previous combined image memorized in combined image memory 160, and the portion of the updating combined image that corresponds to the transparent data in the display control information is not written over the previous combined image. Then, the combined image is read from combined image memory by reader 170 and displayed as a display image on display 180.

Also, when image data #1 and #2 memorized in image data memory 100 are updated, as in the above described case where image data #2 and #3 are updated, the updating combined image, the display control information, and the writing start position (0, 0) and the writing size 110×110, which are coordinate information of the updating combined image, are output to writer 150. In accordance with the display control information and the coordinate information of these, the updating combined image is written over the combined image memorized in combined image memory 160. Then, the combined image is read from combined image memory 160 by reader 170 and displayed as a display image on display 180.

As described above, according to the image combining apparatus of the present embodiment, updating combined images that include updated image data and that correspond to minimum necessary portion, and display control information are generated, and previous combined images are written over in accordance with the generated updating combined images and the coordinate information in the display control information, so that it is possible to reduce the processing involved in combining images.

(Embodiment 5)

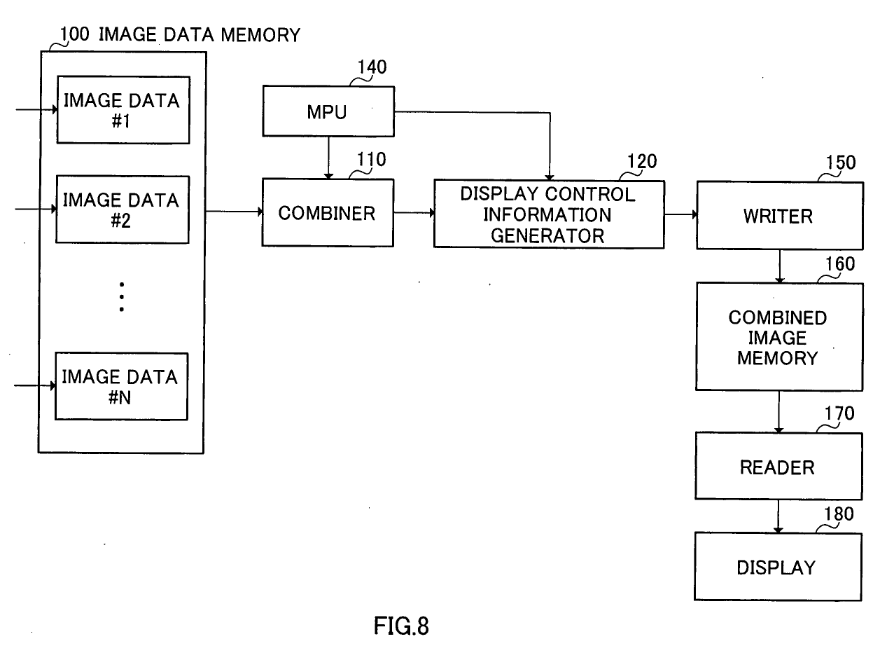

FIG. 8 is a block diagram showing a block diagram of a configuration of an image combining apparatus according to the fifth embodiment of the present invention. Incidentally, the image combining apparatus shown in FIG. 8 adopts the configuration of the image combining apparatus of FIG. 1 minus fixed color data output 130.

The present embodiment is identical to the first embodiment except that no fixed color data is output to the portion that corresponds to unupdated image data in an updating combined image, which is one of the features of the present embodiment, and the operation of the image combining apparatus of the present embodiment will be omitted.

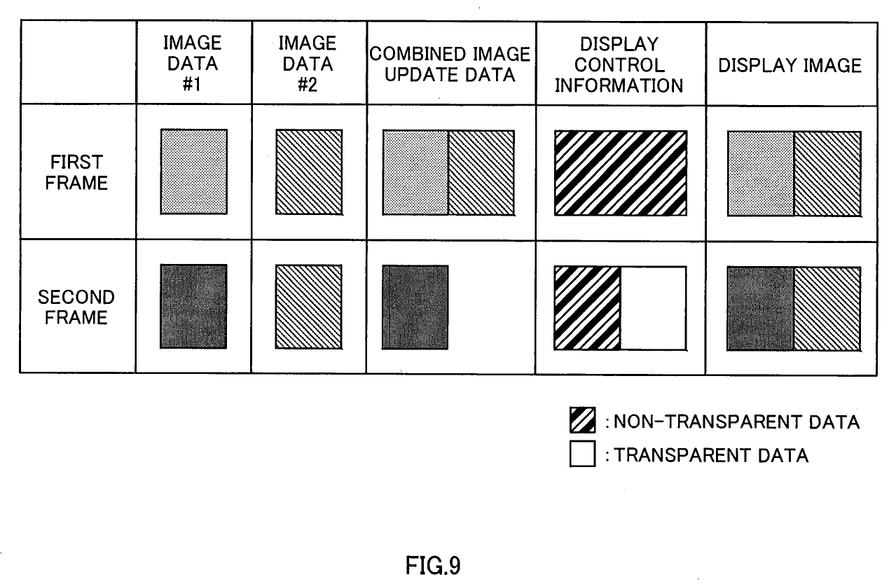

FIG. 9 shows an example of the operation of the image combining apparatus of the present embodiment. The figure shows a case where, of image data #1 and #2 memorized in image data memory 100, image data #1 alone is updated.

Through the same processings as in the first through fourth embodiments, an updating combined image of the first frame that combines image data #1 and image data #2 is memorized in combined image memory 160, and the updating combined image is read by reader 170 and displayed as a display image on display 180.

Next, when only image data #1 memorized in image data memory 100 is updated, update history information indicating to that effect is output to combiner 110. Then, updated image data #1 is read from image data memory 100 by combiner 110. Then, with combiner 110 controlled by MPU 140, image data #1 that is read is placed in a predetermined position and an updating combined image is thus generated. In FIG. 9, image data #1 alone is updated, and thus one image data makes the updating combined image.

Then, display control information generator 120 is controlled by MPU 140, and display control information is generated in which non-transparent data is placed in the portion that corresponds to updated image data #1 and transparent data is placed in the portion that corresponds to unupdated image data #2.

Then, the combined image data and the display control information are output to writer 150, and in accordance with the display control information, image data #1, which is the updating combined image, becomes non-transparent, and the portion of image data #1 in the updating combined image of the first frame memorized in combined image memory 160 is written over. Then, the updating combined image is read from combined image memory 160 by reader 170 and displayed as a display image on display 180.

As described above, the image combining apparatus of the present embodiment is configured to combine only updated image data to make updating combined images, so that the data amount of updating combined images decreases as the data of unupdated image portions decreases, and consequently the processing is lightened.

Incidentally, the above embodiments are all applicable in combination. That is to say, for instance, it is possible to remove fixed color data output 130 from the image combining apparatus of the second embodiment (FIG. 3) and give an updating combined image no fixed color data portion.

Moreover, with the above embodiments, it is also possible to provide a transparent portion in a part of image data memorized in image data memory 100, and, even if the image data has higher priority, let this portion be transparent, in the updating combined image that is generated.

Furthermore, referring to image data subject to updating, if generating and writing an updating combined image over an previous combined image using only updated image data leaves the image data before updating, such as happens when the image data before updating and the image data after updating have different image data formats, it is possible to switch the processing to generate an updating combined image using unupdated image data as well.

The image combining apparatus as described as the above described embodiments suits for use in communication terminal apparatus such as mobile phones and TV conference systems using communication channels.

Thus, according to the present invention, it is possible to reduce the occupation of busses and combine images at high performance and low power consumption.

The present specification is based on Japanese patent application No. 2002-031261 filed on Feb. 7, 2002, entire content of which is incorporated herein by reference.

### INDUSTRIAL APPLICABILITY

The present invention is applicable to image combining apparatus and image combining methods.

1. An image combining apparatus that generates a combined image made up of a plurality of image data, comprising:
a memory that memorizes said plurality of image data;
a combiner that generates an updating combined image using updated image data among the memorized plurality of image data;
a generator that generates display control information indicating a display portion and a non-display portion of the generated updating combined image; and
a writer that, in accordance with the generated display control information, writes said generated updating combined image over a previously generated combined image.

2. The image combining apparatus of claim 1, wherein said combiner generates said updating combined image by combining said updated image data among the plurality of image data with predetermined fixed color data; and
wherein said generator generates said display control information in which a portion of said updated image data is a display portion and a portion of said fixed color data is a non-display portion.

3. The image combining apparatus of claim 1, further comprising a determiner that determines a priority of a portion where said plurality of image data overlap, said priority indicating an order in which said plurality of image data overlap, wherein said generator generates said display control information in accordance with the determined priority.

4. The image combining apparatus of claim 3, wherein combiner generates said updating combined image in accordance with the determined priority.

5. The image combining apparatus of claim 1, wherein said combiner generates updating combined image in a minimum size including said updated image data.

6. The image combining apparatus of claim 1, wherein said generator generates display control information in a minimum size including said updated image data.

7. The image combining apparatus of claim 1, wherein said combiner generates updating combined image using only said updated image data among the plurality of image data; and
wherein said generator generates display control information in which a portion of said updated image data is a display portion.

8. The image combining apparatus of claim 1, wherein, when said updated image data includes non-display data that is for not displaying a part of said image data, said combiner generates updating combined image in which the non-display data portion is transparent.

9. The image combining apparatus of claim 1, further comprising a switch that switches processing when a range of said updated image data does not match with the range of image data before updating, wherein, when said processing is switched, said combiner generates updating combined image by combining said updated image data and unupdated image data.

10. A communication terminal apparatus comprising the image combining apparatus of claim 1.

11. A TV conference system comprising the image combining apparatus of claim 1.

12. An image combining method for generating a combined image made up of a plurality of image data, comprising the steps of:
generating an updating combined image using updated image data among a plurality of memorized image data;
generating display control information indicating a display portion and a non-display portion of the generated updating combined image; and
writing said generated updating combined image over a previously generated combined image in accordance with the generated display control information.
